(19) United States
(12) Patent Application Publication
(10) Pub. No.: US 2004/0204117 A1
(43) Pub. Date: Oct. 14, 2004

(54) Roamers' friendly phone book - method and device

(75) Inventor: Moshe Weiner, Yahud (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 10/107,305

(22) Filed: Mar. 28, 2002

(51) Int. Cl. H04Q 7/20

(52) U.S. Cl. 455/564; 455/558; 455/432.1

(57) ABSTRACT

A method and device for assisting a user of a mobile communication device. Country codes for numbers to be dialed are added to stored telephone numbers either by user input or automatically using a stored database. Further, user-specific data stored within the mobile device is updated automatically as the device is transported from one location to another location.

### FIELD OF THE INVENTION

The present invention relates generally to the field of wireless communications and more particularly to the field of wireless services provided to a wireless caller when the wireless caller roams outside the coverage of his home network.

### BACKGROUND OF THE INVENTION

Most mobile communication handsets today enable storage of various names and telephone numbers to enable rapid recall and dialing when the handset user wishes to call any one of the stored numbers. For example, electronically stored telephone directories can be maintained within a mobile handset's memory. Such directories can store telephone numbers of, for example, personal friends, business associates or even businesses from which an individual may want to purchase products or services, such as local transportation services, restaurants, etc. When the handset user wishes to call a particular person or business, he or she browses through the stored names and associated numbers and makes a selection. The handset then attempts a connection to that number through the user's network.

Under certain circumstances, however, the numbers stored within the user's handset may not be appropriate for connecting the user's handset to the desired person or business. For example, when a user attempts to place a call from within his or her home country, i.e., the country in which his or her mobile handset is registered, to a number outside the user's home country, it is typically necessary to provide a country code prefix to the local number to ensure the call is first routed to the proper country and then routed through the network to the local number. If the stored number does not have the country code prefix, the call will either fail to connect at all or it will incorrectly connect to a local number within the user's home country, as opposed to a local number within the country the user is attempting to call.

Providing a country code prefix is also required when the user roams outside the user's home country and attempts to place a call to a number within the user's home country or within another foreign country. Here again, if the country code prefix is not used, the call will either fail to connect at all or it will incorrectly connect to the local number within the country from where the user is calling.

Another unfortunate scenario that arises when a user travels outside his home country is the inability of the user to utilize certain applications by using short dialing codes. For example, many wireless systems facilitate connection to services, such as voice mail retrieval, etc., by dialing only a few numbers and/or characters, e.g., “*151” for connecting to voice mail services in Israel. However, if the user has traveled beyond the coverage area of the system that provides such services, dialing the short dialing codes corresponding to the service will not result in the desired connection. In view of the issues discussed above, a mobile system that provides dialing assistance to a roaming user would be beneficial.

One conventional system that attempts to address at least one of the issues discussed above is a server-based system that provides assistance to a user roaming outside his home country, even if the roamer neglects to provide a country code. This conventional system is referred to herein as the “calling assistance server”. The calling assistance server is a server to which every call is routed that could not be completed due to a problem with the dialed number, e.g., the area code did not exist in the host system, or a country code of the destination, when needed, was missing. The calling assistance server also receives information about the caller, e.g., the caller's home network, the country the network is operating in, etc.

By knowing the country of the caller or, more specifically, the country that the caller's handset is registered in, the conventional calling assistance server is able to determine several short dialing codes. For example, as mentioned above, dialing “*151” in Israel within a GSM network routes the caller to his or her voice mailbox. However, if the caller is in, for example, the United Kingdom as opposed to Israel, dialing “*151” will not allow the user to connect to his or her voice mail since the network to which the caller will be connected in the United Kingdom does not recognize “*151” as a voice mail short dialing code. Furthermore, if a caller from Israel dials “03 123456”, from within Israel, he or she will be connected to a number “123456” in Tel Aviv—“03” being the area code for Tel Aviv. However, if the caller dials the same number when roaming in the United Kingdom, the call will not be routed to the number “123456” in Tel Aviv and will instead be routed to the local number “123456” in the United Kingdom, if that particular number is a valid number in the United Kingdom, or, alternatively, the connection will not be completed.

In the example just discussed, the conventional dialing assistance server recognizes that the caller belongs to an Israeli network and re-routes a short coded dialed number to the appropriate “real” destination. In other words, in the examples above, “*151” is translated to “+972-54-151 000”, and “03 123456” is translated to “+972 3 123456”.

However, the conventional system described above requires that an expensive server be deployed in every network in the world or, at least, a server with extensive computing power deployed in each of several central locations. These added servers are required in order to deal with the enormous number of telephone calls that are not completed for any of a wide variety of reasons, including the reasons discussed above.

Furthermore, solutions like the conventional calling assistance server described above assist the caller only when the caller attempts to place a call and the call can not be completed. This situation is extremely disadvantageous if, for example, the user is eagerly trying to call a business contact and reaching the party in a short period of time is very important. The conventional system does not provide rapid assistance and, as a result, the user may not reach the called party in time.

There are other circumstances under which the numbers stored within a user's handset may not be appropriate for connecting the user's handset to a desired person or business. For example, as is often the case, international travel requires extensive preparations on behalf of the traveler. However, some of the preparations are often duplicated when traveling from one country to the next, e.g. obtaining, in advance, the telephone numbers for the air carrier office, the taxi service in a certain city, popular entertainment organizations, or even obtaining details regarding restaurants, such as location and hours of operation.

There are a few conventional approaches that attempt to address the above described issue. For example, location-based services for mobile users enable a mobile network to push short messages, e.g., SMS messages, to a handset located in a certain area. These short messages contain relevant information with respect to the certain area. For instance, special deals in regard to local shops or restaurants, etc.

Another known method for assisting the handset user in obtaining relevant information when roaming is a system that enables the user to browse the Internet, e.g., via a WAP browser, for information about local services, such as taxi services, shops, restaurants, etc. In the third generation of mobile networks (3G) as well as in 2.5G (GPRS, EDGE, etc.) the user can be continuously connected to an IP network, like the Internet. Thus, the user can get information that is pushed to him by the IP network. Push services can be delivered by using either the WAP browser or immediate messaging techniques via an IP network—similar to the concept of ICQ immediate messaging in non-wireless applications.

Conventional services like the ones mentioned above are neither immediate, e.g., WAP browsing takes a significant amount of time, nor are they focused. For example, even though the user can specify in advance what types of information he or she is interested in, generally speaking, a system that performs location-based push services can never sufficiently guess what kind of information the user needs when the user is at a certain location at a certain time. Accordingly, it would be much more useful if the user could search for information about services (such as taxi, restaurants, theaters, etc.) within his or her handset, in the same way he or she looks for a number in the mobile telephone directory within his or her handset.

### OBJECTS OF THE INVENTION

In view of the issues raised above in regard to inefficient and/or ineffective mobile dialing assistance when a mobile user is roaming, the present invention provides a device and method for assisting a roaming mobile user in dialing a desired number and assisting the roaming mobile user in efficiently obtaining relevant information regarding certain businesses or services.

### SUMMARY OF THE INVENTION

A device in accordance with the present invention assists the mobile user in obtaining, storing and dialing desired telephone numbers, even at the preliminary stage of entering numbers into the memory of a handset. For instance, a device in accordance with the invention can query the user whether he or she wants to add country codes for his or her stored numbers. At the preliminary stage, when the user of the device performs the task of adding a new telephone number to the memory of the device, the device queries the user whether a country should code should be added to the number. If the user desires a country code be added, the country code can be input by the user, or it can be provided from a stored list of country codes within the device. Alternatively, instead of querying the user, a device in accordance with the invention can automatically add the home network country code of the device to each stored number. Thus, when roaming, telephone numbers can be dialed without call completion problems due to missing country codes.

Additionally, a device in accordance with the present invention recognizes the name of a visited network and stores in its memory a table for translating short codes to appropriate telephone numbers. For example, in the situation mentioned above where the user dials “*151” because he or she wants to connect to his or her voice mail server and the device recognizes that the user's home network is in Israel, by determining that the handset is now calling from the United Kingdom, the device translates the “*151” dialed number into “+972 54 151000”. The device can then either automatically dial the new number or, alternatively, query the user if the new number should be dialed.

According to the invention, two functionally related logical building blocks are employed. One logical building block is a “friendly” telephone directory for mobile roamers. The second logical block addresses the issue of providing dialing assistance to mobile roamers, for example when the required country code is missing.

In accordance with the invention, a large database is used that can be updated over-the-air (OTA). The device can determine the location, e.g., which country, the user is in. This determination is done by observing the name and other network identifications that are sent to a GSM handset when the handset enters the coverage area of a particular network. In regard to location, it is possible to determine both the city the user is in as well as the country. Thus, the present invention enables the roamer to have an instantly updated searchable telephone directory. As the user roams from one location, covered by a corresponding network, to another location, covered by a second network, the user's telephone directory, stored within the handset, is automatically updated with current, location-relevant telephone numbers, e.g., updated numbers for theatres, taxi services, train stations, air carriers, restaurants, etc.

Further, additional data, besides a telephone number, corresponding to each updated item can also be stored. For instance, address information and hours of operation for each business can be updated and stored as well. This information can be updated when the user is within the coverage area of the local roaming network. The device can be programmed, e.g., with certain business data, before the user embarks on his trip and thus he will have all the available information with him when traveling.

In accordance with one embodiment, the additional data is sent in a set of concatenated short messages. Each short message includes a header that identifies the message as an update message. The received update information is added to the data already stored on the user device on the handset. Furthermore, if the received data corresponds to data that was already stored on the user device, then the stored data is updated, or replaced, with the update data. For example, if there exists an entry in the stored directory for a “local taxi service”, upon receiving an update message in the handset when roaming from a first location into a second location, the actual number, or other data, corresponding to the first location for the “local taxi service” entry is updated with data corresponding to a taxi service in the second location.

Update data, such as mentioned above, can include telephone numbers, operating hours of the offices corresponding to the telephone numbers, e-mail addresses, etc. Another update method in accordance with the invention includes updating SIM card data over-the-air—an operation typically performed by the operator. After the SIM card is updated, an “Intermediate Smart Card (ISC)” (described below) reads the update data from the SIM card and update itself. In this update method, the information is transmitted to the SIM card via the telephony network.

According to another embodiment of the invention, various types of devices directed to different types of users can be provided. For example, mobile devices programmed with a tourist in mind include tourist-relevant information, such as, taxis, hotels, transportation, places to visit, etc. A different type of device can be provided for a professional traveler, such as people attending a high-tech conference who may want to find in their handset directory the relevant numbers of the conference center, etc. Further, younger travelers may want to get a still different device that is programmed to include data for such things as rock concert ticket offices, dance clubs, etc.

A method or device in accordance with the present invention is handset-based and enables a mobile user to have an adaptive telephone book that is changed according to the user's location. Also, a method and a device in accordance with the present invention is updated, over-the-air (OTA), when the user is located within the relevant coverage area. Furthermore, the device does not require the user to be connected to a special telephone book service in order to obtain local telephone numbers. This is so due to the fact that the telephone book is stored within the handset.

A method and a device in accordance with the present invention stores and dials mobile telephone numbers and also stores additional relevant data associated with the stored numbers.

A method and a device in accordance with the present invention enables automatic modification of a telephone number entered on a handset and, further, dials the modified number with a correct country code with or without prompting the user.

A method and a device in accordance with the present invention determines which country the user is roaming in and prompts the user to enter country codes before dialing or storing a telephone number.

A method and a device in accordance with the present invention translates short dialed numbers to an MS ISDN (standard for telephone numbers) number, based on the country in which the user's home network is in and the country he or she is roaming in. An MS ISDN (Mobile Subscriber—Integrated Services Digital Network) number is the dialable number that callers use to reach a mobile, and wired line, subscriber. Some telephones can support multiple MSISDNs—for example, a U.S. based MSISDN and a Canadian based MSISDN. Callers dialing either number will reach the subscriber.

### BRIEF DESCRIPTION OF THE DRAWINGS

FIG. 1 is a block diagram of a handset in accordance with the present invention.

FIG. 2 is a block diagram showing an overall communication network in accordance with the present invention.

FIG. 3 is a flow chart illustrating a method in accordance with a first embodiment of the present invention.

FIGS. 4A-4D is a flow chart illustrating a method in accordance with a second embodiment of the present invention.

### DETAILED DESCRIPTION OF THE PREFERRED EMBODIMENTS

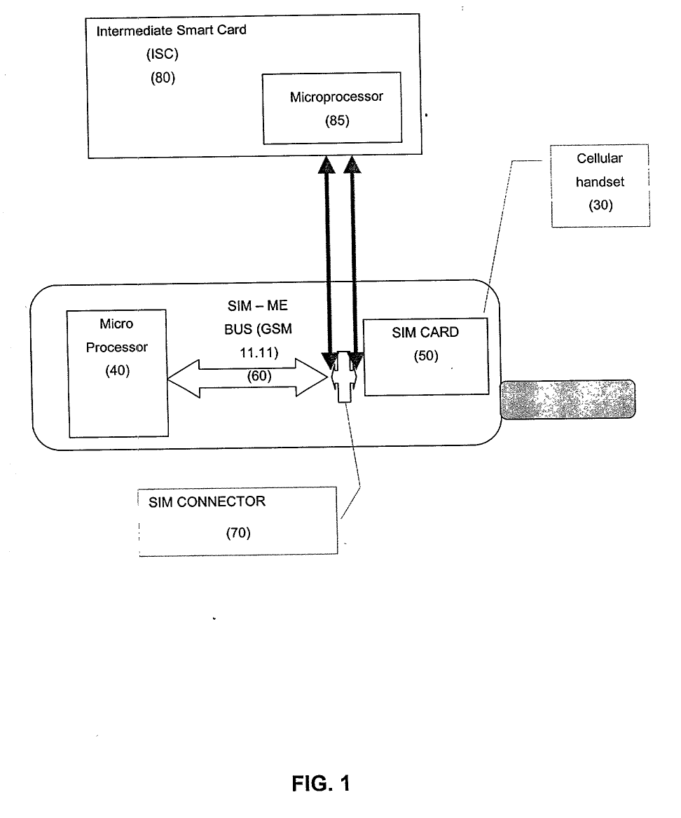

In accordance with an embodiment of the present invention, referring to FIG. 1, an Intermediate Smart Card (ISC) (80) is interfaced with a GSM mobile handset (30). ISC (80) connects with the GSM 11.11 bus (60) of handset (30) and, by utilizing the SIM Toolkit set of commands, i.e., using GSM 11.14 standard commands, interrogates the microprocessor (40) of the handset (30) regarding the identification of the mobile network that provides service to the handset (30). Linking the ISC (80), or more particularly the microprocessor (85), to the GSM 11.11 bus (60) is detailed in commonly owned co-pending U.S. patent application Ser. No. 09/915,563 by the same inventor, which is incorporated herein by reference for all it teaches. Also, ISC (80) is prompted each time there is a change with respect to the chosen mobile service provider. ISC (80) is alerted to any changes in mobile service provider by monitoring signals on the GSM 11.11 bus (60).

If the user of handset (30) is roaming, i.e., traveling outside the coverage area of his or her home network, ISC (80) determines the location of the user by interpreting data on the bus (60) and, based on the determined location, a certain part of the memory of the ISC (80) is made available for the user's information as if the information was stored in his SIM card (50). For example, the data stored on the ISC can be; i) country dialing codes; ii) service providers (such as embassies, air carriers, etc.); iii) telephone numbers; iv) operating hours; v) e-mail addresses; vi) a list of short codes and their corresponding long numbers; vii) business related telephone numbers, e.g. for the company's offices in the roamed country, etc.

Also, the information stored within ISC (80) can be transferred to the SIM card. However, the memory of the ISC is typically larger than the memory on the SIM card and therefore, typically (depending on the SIM card used) not all of the information stored within the ISC can be transferred to the SIM card. Nevertheless, the user device (ISC) is also a personal device, as is the SIM card and, therefore, the ISC can be removed and inserted into another telephone, assuming the new telephone has similar physical dimensions and can accommodate the ISC.

Reception and storage of the new location information, etc., by the ISC (80) is possible because ISC (80) is interfaced to the handset (30) between the SIM card (50) and the micro-processor (40) of the handset (30). The database stored in the handset can be updated over-the-air (OTA) using the standard OTA GSM capability or by using a special short message service (SMS) message.

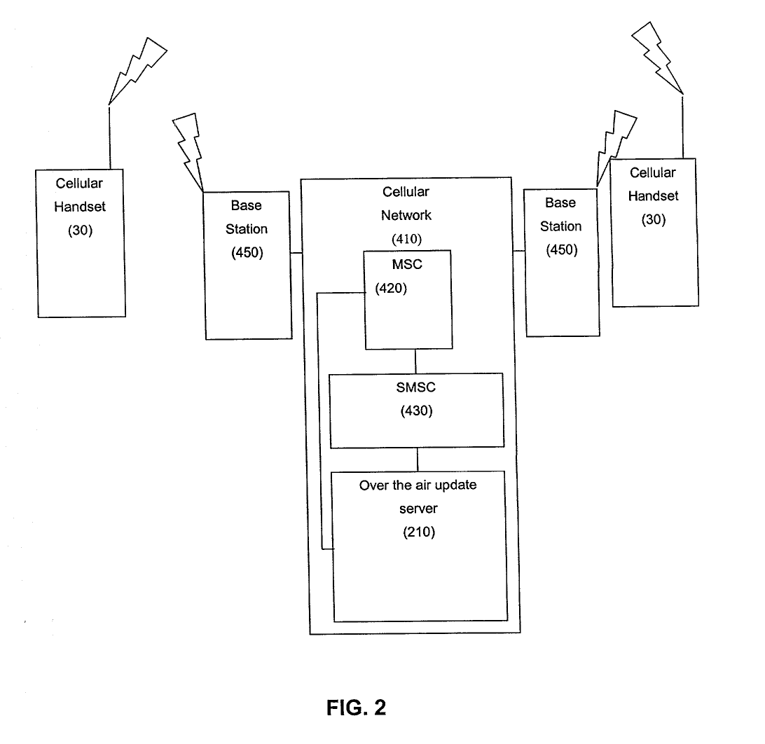

As illustrated in FIG. 2, in order to provide the OTA update service, a dedicated server (210) is provided within the mobile network (410). It should be mentioned that ISC (80), with a secondary microprocessor (85), (FIG. 1), can be connected to the GSM 11.11 bus (60) by using the standard SIM connector (70), which is the standard connector that the SIM card (50) is connected to when it is inserted into the handset (30).

In order to enable the OTA service for updating the ISC (80), dedicated server (210) is preferably connected to the Short Message Service Center (SMSC) (430), which is part of an overall system in accordance with the present invention. The architecture of the overall system in accordance with the present embodiment includes at least one base station (450) operable to conduct radio communication with the handsets (30) and a mobile network (410). Network (410) includes Mobile Switching Center (MSC) (420), SMSC (430) and the OTA update server (210), connected to the SMSC (430).

The SMS service, one technique by which handset (30) receives data, makes use of the SMSC (430), which acts as a store-and-forward system for short messages. The wireless network provides the mechanisms required to find the destination station(s) and transport short messages between the SMSC and wireless stations. The MSC (420) is the mechanism by which each wireless call entering the network (410) gets routed to the proper destination handset (30). Thus, if a standard GSM OTA update of the added microprocessor (85) is needed, the over-the-air update server (210) can be connected to the switch for the GSM system, i.e., the MSC (420).

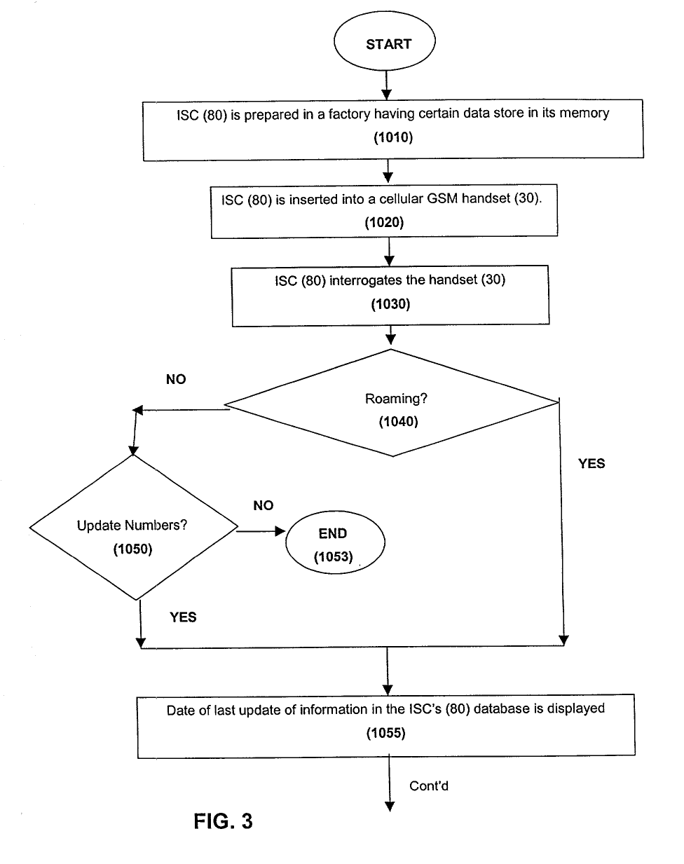

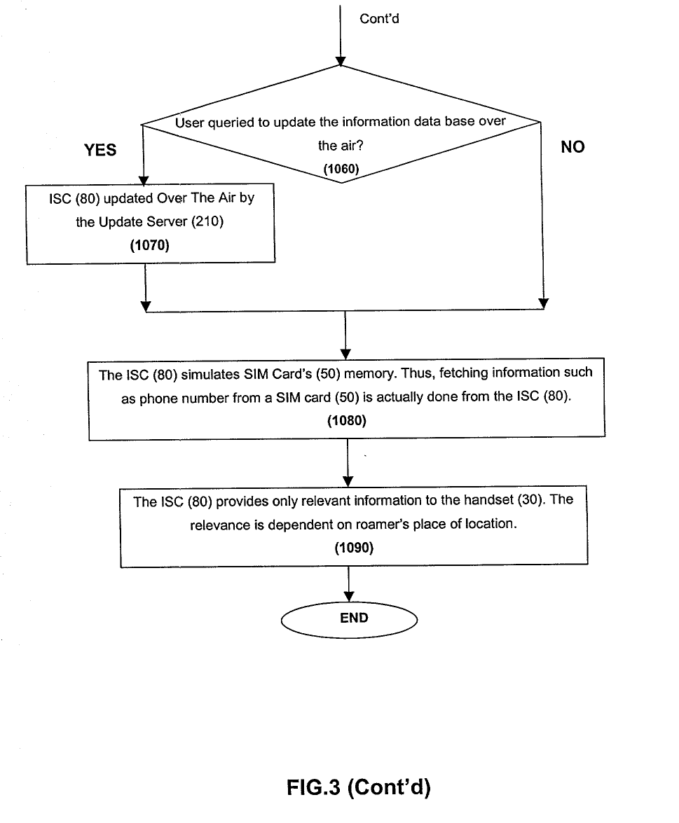

FIG. 3 illustrates a mobile communication method in accordance with an embodiment of present invention. In the following description of FIG. 3, the 4-digit reference numbers refer to the corresponding operation in FIG. 3, and the 2-digit reference numbers correspond to items in the block diagram of FIG. 1.

The ISIC (80) includes a memory that, e.g., initially contains a database of information, such as telephone numbers, addresses, etc., related to a certain subject, such as tourism, business contacts, leisure travel, etc. (1010). After ISC (80) is programmed with the above-mentioned data, it is inserted into, or otherwise interfaced with, a mobile GSM handset (30) using the GSM 11.11 standard bus that connects the handset's microprocessor (40) with a standard SIM card (50). (1020).

ISC (80) interrogates the handset (30) using GSM toolkit commands (standard GSM 11.14) for the service providing network's identification. (1030). By analyzing the data returned from the microprocessor (40) in response to the interrogation, ISC (80) determines whether the handset (30) is roaming. (1040).

If the handset (30) is not roaming, ISC (80) queries the user, by displaying a text message on the display (not shown) of handset (30), or by some other appropriate means, e.g., audible question, etc., whether he or she wants to obtain telephone numbers for the stored items that are compatible with the user's home network, i.e., numbers that the network can interpret and to which the network can connect the user. (1050). Step 1050 is useful, for example, when an ISC (80) card is utilized for home network usage for special occasions having corresponding special telephone numbers for each occasion, e.g., holiday travel deals, major sporting events, like the Olympic games, etc. Thus, in accordance with the present embodiment, all event-relevant telephone numbers are stored in the ISC. If the user does not wish to obtain telephone numbers for his home network, i.e., update the currently stored numbers, the ISC performs nothing further in regard to updating the stored telephone numbers and the process ends. (1053).

However, if the user wishes to obtain updated relevant telephone numbers corresponding to his or her home network, the operation proceeds in a similar manner as it would have if the ISC (80) had determined that the handset was roaming in step (1040). That is, ISC (80) displays, on the handset's display, the date of the last update of information in the database of ISC (80). Displaying data on the display of the handset is performed in accordance with SIM Toolkit commands (GSM 11.14). (1055).

After the date of the last update is made known to the user, ISC (80) queries the user whether he or she would like to update the information database over-the-air. (1060). If the user responds in the affirmative, by pressing a designated key (not shown) on the handset (30), or in some other appropriate manner, such as by verbally responding in the affirmative if voice recognition is enabled on the handset, the ISC (80) is updated over-the-air by the update server (210). (1070). Since the over-the-air update server (210) is located at the premises of the service provider (410), it might be possible to enable this update to be sent free of charge. Alternatively, each message sent via a telephony network can be a chargeable event. Accordingly, a billing server is responsible for creating CDRs (Call Duration Registration) and then the billing server can create a bill, based on a charging table. The charging table takes into consideration the user who sent the message, to whom the message was sent, and what type of the message it was. Thus it is up to the system operator to decide whether the user is to be charged for OTA related messages. The OTA server can provide the billing server with information for the CDR creation informing that certain messages that were sent at a certain time from a certain user to the OTA server or vise a versa, are update messages. The billing server then analyzes its charging table to determine whether update related messages are free of charge or if they should be charged to the user.

If the user chooses not to have the ISC (80) updated over-the-air, by selecting the appropriate key on the handset, etc., or if the user has chosen to update the information over-the-air in step (1070) and the update process is complete, ISC (80) simulates the memory of SIM Card (50). In other words, ISC (80) provides microprocessor (40) with updated information as if ISC (80) were the SIM card. The fact that microprocessor (40) is receiving data from ISC (80) instead of from SIM card (50) is transparent to the microprocessor (40).

As a result of using GSM toolkit commands, channeling of data from ISC (80) instead of from the SIM card (50) is also transparent to the user. Thus, a request to fetch information, such as telephone numbers, from a SIM card (50) is actually accomplished by fetching the data from ISC (80). (1080). Because the information is updated in accordance with the handset's location, the ISC (80) provides both time-relevant and location-relevant information to the handset (30). (1090).

Another embodiment in accordance with the present invention will now be described. Referring to FIG. 1, an ISC (80) with a microprocessor (85) corresponding thereto is interfaced between the handset's microprocessor (40) and the SIM card (50). Thus, the ISC interfaces with the GSM 11.11 bus (60) between the dialing device, i.e., microprocessor (40) and the storage device, i.e., SIM card (50), or, in other words, between the device that controls the keyboard (not shown) and the device that receives the keyed number, and the SIM card (50).

In accordance with this embodiment there are four basic scenarios, as follows:

1) A roaming mobile user attempts to key-in a number without a country code;

2) A roaming mobile user attempts to dial a stored number that has no country code prefix;

3) A mobile user attempts to save a telephone number but does not enter a country code; and

4) A roaming mobile user attempts to dial a short-code number, such as “*151”.

For each of these cases, the present invention provides a method and a device for prompting the user for the country code or an alternative number, while querying the user whether he or she would like to add his or her home country code, roaming country code, alternative number (when short codes are keyed) or any other country code. Because a device in accordance with the invention supports the GSM 11.11 and GSM 11.14 standards, it is possible for ISC (80) to add to the number, in any of the above-mentioned cases, a prefix of a country code, or suggest to the user dialing an alternative number, without the user being involved in actual keying but only agreeing to the suggestion of the ISC (80).

Also, in accordance with a further embodiment of the present invention, the user can be queried about the destination country, i.e., the name of the country to which the user is planning to travel, or the name of the country he or she has already traveled to and is presently located. Thus, the user does not have to know the country dialing code for each country. The ISC (80) stores all country codes within its memory and selects the code corresponding to the country name entered by the user. ISC (80) can also send the required signals, via GSM bus (60) to microprocessor (40) to dial the new number that has the prefix of the country code appended thereto. The addition of the country code can also be done automatically, without any user interference, if the user desires to use the country code of the home country. That is, the code of the country in which the handset was located when the telephone numbers were originally stored in the device.

An ISC (80) in accordance with the present invention interrogates the microprocessor (40) of the handset (30) to determine whether the user is roaming and prompts the user to enter his or her home country code when dialing a telephone number that was stored while located at the home country, etc. Further, ISC (80) can be connected to a GSM handset via the SIM Card connector (70) shown in FIG. 1.

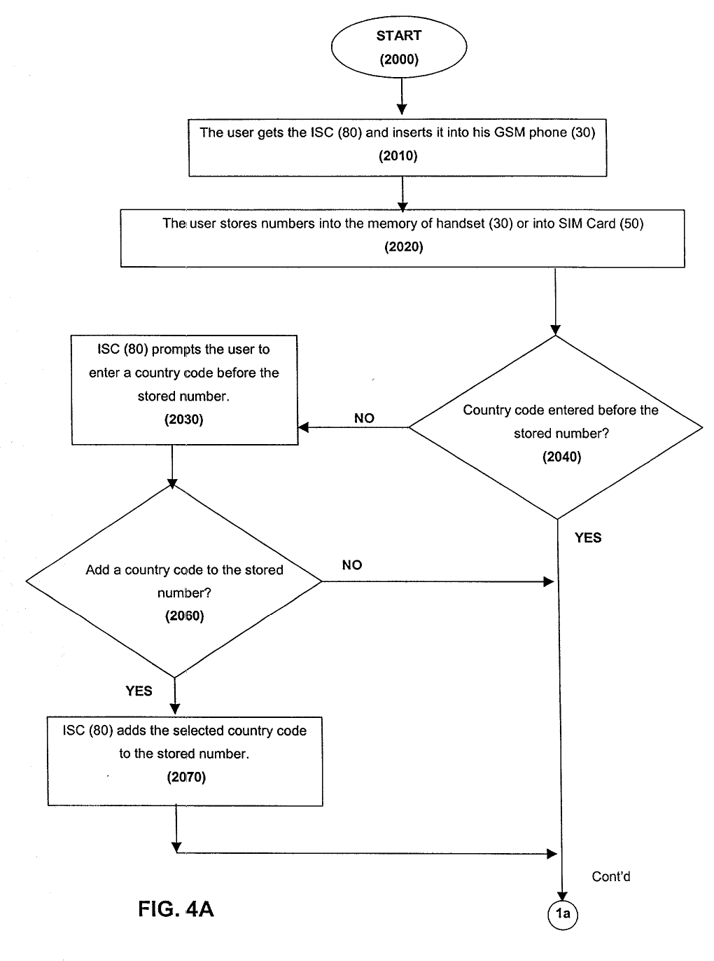

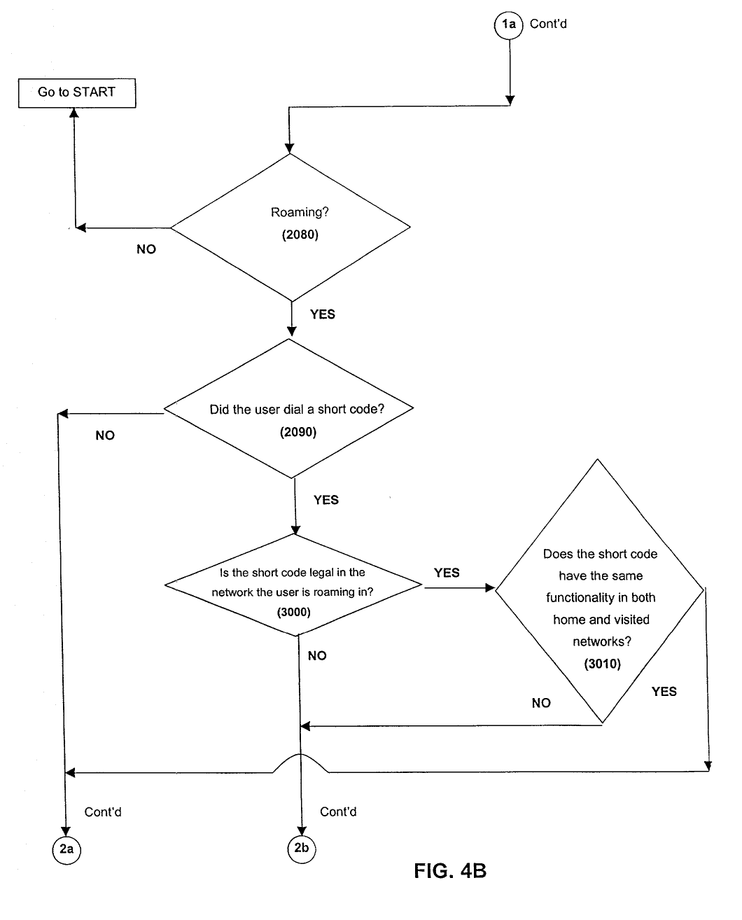

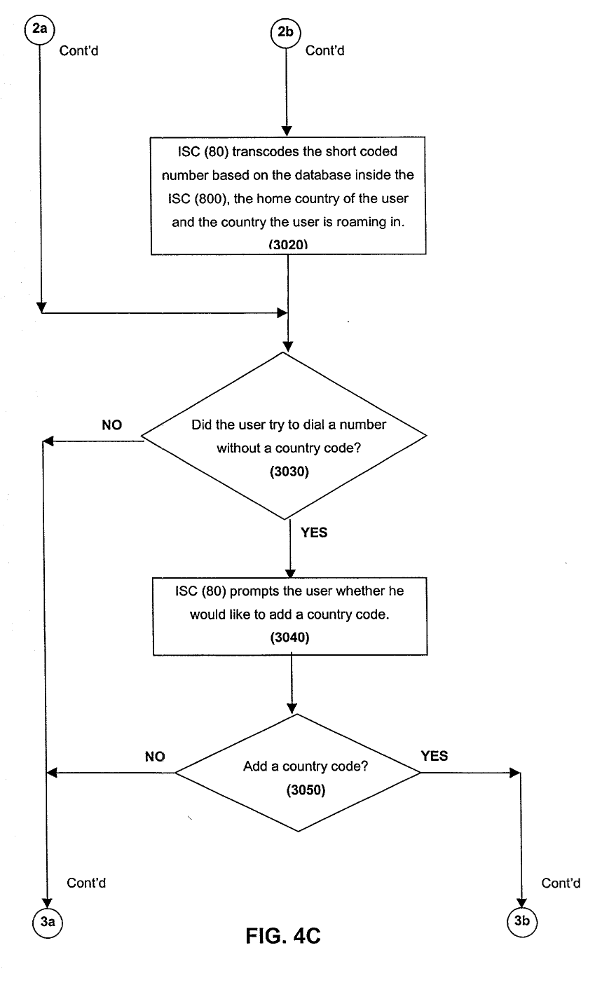

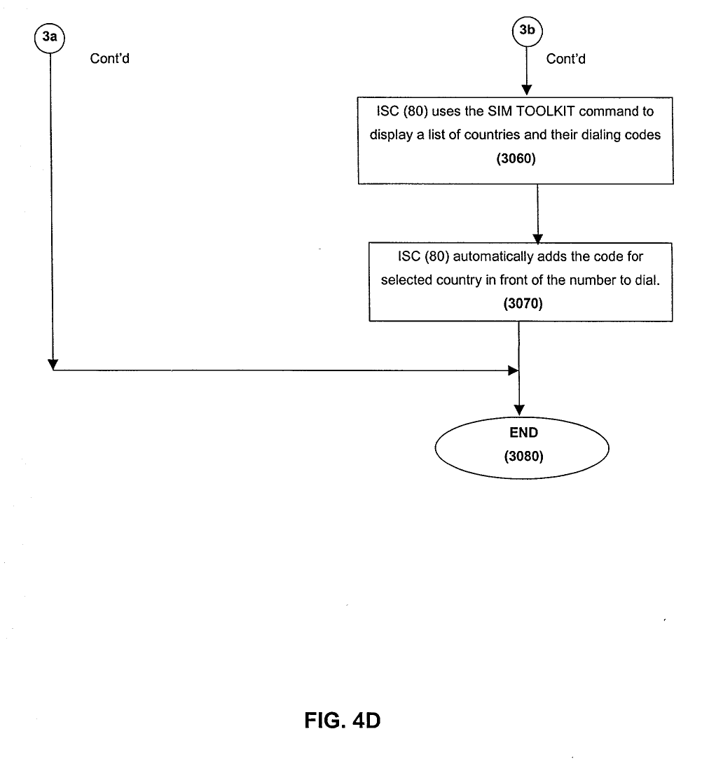

FIG. 4 illustrates a mobile communication method in accordance with a further embodiment of the invention, which will now be described. In the following description, the 4-digit reference numbers refer to the corresponding step in FIG. 4 and the 2-digit reference numbers correspond to the block diagram of FIG. 1. Initially, the user gets the ISC (80) and inserts it into his GSM phone (30). (2010). The user then stores numbers into the memory of his handset (30) or into the SIM Card (50). (2020). ISC (80) determines whether each entered number has a country code corresponding thereto. (2040). If an entered number does not have a corresponding country code entered with it, the ISC (80) prompts the user to enter a country code for that number. (2030). In accordance with one aspect of the present embodiment, the default is for the ISC (80) to use the country code of the user's home country. In order to add a country code, the ISC (80) uses a SIM TOOLKIT command in order to display a list of countries and their corresponding dialing codes. Thus, the user does not have to remember various counties' dialing codes. Furthermore, the user only has to select a country from the displayed list and the ISC (80) adds the corresponding country code to the entered number. (2070). Also, the user is queried whether he or she would like to add a country code before the country code is added in step (2070). (2060).

ISC (80) determines whether the user is roaming. (2080). If the user is roaming, that is, he or she has left the coverage area of his or her home network, the ISC (80) determines if a short code has been entered into the handset. (2090), for example, whether “*151” has been entered, which as discussed above would connect the user to a voicemail retrieval service if the handset were in Israel when it was dialed. The ISC can determine whether a short code has been entered since it monitors the GSM 11.11 bus (60).

If a short code has been entered, the ISC (80) determines whether the short code that was keyed is legal in the network in which the user is located. (3000). Even if the entered short code is legal in the present network, it is necessary to determine whether the short code has the same functionality as was intended by the user when the short code was entered. (3010). For example, does the short code have the same result when dialed in the new country, or more specifically, within the new host network, in which the user is presently traveling as it does when dialed in the user's home country.

If the entered short code has the same functionality, both in the home and visited networks, then no interference by ISC (80) is required. However, if the keyed short code is not legal in the visited network, as determined in (3000), or the entered short code does not have the same functionality in the host network as it does in the home network, then the ISC (80) intervenes and assists the user. In particular, the ISC (80) translates the entered short code into an MS ISDN number, based on; i) the database stored within the ISC (80); ii) the home country of the user; and iii) the country the user is roaming in. (3020).

By looking up required information in the database stored within ISC (80), ISC (80) is able to make the above-described determinations, i.e., whether the keyed short code is valid in the country the user is roaming in, (3000), whether such a code exists, and more importantly, whether the code, if entered when in a host or visited network, has the same functionality as in the home network, (3010).

ISC (80) further determines whether the user is attempting to connect to a telephone number without a corresponding county code. (3030). The number to which the user is attempting to connect could have been manually keyed-in by the user or retrieved from the memory of the handset. If the user is attempting to connect to a number without a country code, ISC (80) queries the user whether he or she would like to add a country code. (3050).

If the user does not want to use a country code, for whatever reason, the process is ended. (3080). However, if the user wishes to use a country code, ISC (80) uses a SIM Toolkit command to display a list of countries and their associated dialing codes. (3060). Thus, the user does not have to remember various counties' dialing codes. Furthermore, the user only has to select a country and the ISC (80) automatically adds the required country code to the number being dialed. (3070). For instance, ISC (80) adds the selected country's code to the beginning of the number to be dialed.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A communication device comprising:
a wireless telephone; and
a personal device operable to connect to an internal bus of the wireless telephone and further operable to determine at least one additional code to be included with a desired telephone number when the corresponding wireless telephone is moved from a first location to a second location.

2. A communication device in accordance with claim 1, wherein the at least one additional code is used to identify the second location.

3. A communication device in accordance with claim 1, wherein said personal device automatically adds the additional code to the desired telephone number when the corresponding wireless telephone is moved from the first location to the second location.

4. A communication device in accordance with claim 1, wherein said personal device generates a query to a user of said wireless telephone regarding whether the additional number should be added to the desired telephone number.

5. A communication device in accordance with claim 1, wherein the internal bus of said wireless telephone is in accordance with GSM standard 11.11.

6. A communication device in accordance with claim 1, wherein said personal device communicates with a primary microprocessor of said wireless telephone in accordance with GSM standard 11.14.

7. A method of maintaining updated data within a mobile telephone, the method comprising:
interfacing a special purpose device to an internal bus of the mobile telephone, wherein the special purpose device includes a microprocessor and a memory, the memory having data stored within that is personally relevant to a user of the mobile telephone and specifically relevant to a first location of the user.

8. A method in accordance with claim 7, further comprising:
automatically updating the data stored within the memory of the special purpose device when the mobile telephone is moved from the first location to an second location.

9. A method in accordance with claim 7, further comprising:
displaying, on a display portion of the mobile telephone, the date or time that the data stored within the special purpose device was last updated.

10. A method in accordance with claim 7, further comprising:
determining whether the mobile telephone has traveled from a coverage area of a first mobile network to a coverage area of a second mobile network, wherein said determination is performed by the special purpose device by monitoring signals on the bus.

11. A method in accordance with claim 10, further comprising:
if the special purpose device determines that the mobile telephone has traveled from a coverage area of a first mobile network to a coverage area of a second mobile network, querying a user of the mobile telephone whether the data stored within the memory should be updated with data relevant to the coverage area of the second mobile network.

12. A method in accordance with claim 11, further comprising:
automatically updating the data stored in the memory of the special purpose device with data relevant to the coverage area of the second mobile network.

13. A method in accordance with claim 12, wherein the data includes at least one of local telephone numbers, hours of operation, addresses, or any other information pertaining to a local business, building or location.

14. A method in accordance with claim 12, wherein said updating is performed using at least one message sent over the air (OTA) from an OTA server located within the second mobile network.

15. A method of maintaining updated data within a mobile telephone having a primary microprocessor and a primary memory, the method comprising:
interfacing a special purpose device with an internal bus of the mobile telephone, wherein the special purpose device includes a secondary microprocessor and a secondary memory;
storing, within the primary memory of the mobile telephone, at least one telephone number;
determining, by the special purpose device, whether the stored telephone number has a country code included therewith;
associating, by the special purpose device, a corresponding country code with the stored telephone number, if the special purpose device determines that the stored telephone number does not have a country code included therewith.

16. A method in accordance with claim 15, wherein said associating is performed by the special purpose device and the corresponding country code is automatically added to the stored telephone number.

17. A method in accordance with claim 15, further comprising:
querying the user of the mobile telephone whether the corresponding country code should be added to the stored telephone number; and
adding the corresponding country code to the stored number.

18. A method in accordance with claim 15, further comprising:
determining whether the mobile telephone has traveled from a coverage area of a first mobile network to a coverage area of a second mobile network, wherein said determination is performed by the special purpose device by monitoring signals on the bus.

19. A method in accordance with claim 18, further comprising:
if the mobile telephone has traveled from the coverage area of the first mobile network to the coverage area of the second mobile network, determining whether a short-code has been input to the mobile telephone, wherein the short-code is associated with a service that the user of the mobile telephone wishes to initiate; and
if a short-code has been input, determining whether the input short-code is a functional short-code in the coverage area of the second mobile network.

20. A method in accordance with claim 19, further comprising:
if the input short-code is a functional short-code in the coverage area of the second mobile network, determining whether the function of the input short-code in the second mobile network is the same as a function of the input short-code in the first mobile network.

21. A method in accordance with claim 20, further comprising:
translating the input short-code into an alternate short-code that has the same function in the second mobile network as does the function of the input short-code in the first mobile network.

22. A method in accordance with claim 21, further comprising:
if a user attempts to dial a telephone number without entering a country code, querying the user whether a country code should be added to the entered telephone number;
automatically adding the corresponding country code to the entered telephone number.
